(19) United States
(12) Patent Application Publication
(10) Pub. No.: US 2022/0290285 A1
(43) Pub. Date: Sep. 15, 2022

(54) HIGH ENTROPY CERAMIC THERMAL BARRIER COATING

(71) Applicant: General Electric Company, Schenectady, NY (US)

(72) Inventors: Surinder Singh Pabla, Greer, SC (US); Eklavya Calla, Bengaluru (IN); Mohandas Nayak, Bengaluru (IN); Arundhati Sengupta, Bengaluru (IN); Adarsh Shukla, Bengaluru (IN); Jon Conrad Schaeffer, Greenville, SC (US); Krishnamurthy Anand, Bangalore (IN)

(21) Appl. No.: 17/231,172

(22) Filed: Apr. 15, 2021

(30) Foreign Application Priority Data
Mar. 9, 2021 (IN) 202111009892

(51) Int. Cl. C23C 4/11; C23C 4/134

(52) U.S. Cl. CPC C23C 4/11; C23C 4/134

(57) ABSTRACT

A high entropy ceramic (HEC) composition includes at least three different rare earth (RE) oxides and at least one of hafnium dioxide (HfO₂) and zirconia oxide (ZrO₂). The at least three different rare earth oxides being equimolar fractions. In one aspect, the high entropy ceramic (HEC) composition can be used in a thermal barrier coating.

### TECHNICAL FIELD

The disclosure relates generally to thermal barrier coatings. In particular, the disclosure relates to low thermal conductivity, high entropy ceramic (HEC) compositions in thermal barrier coatings.

### BACKGROUND

Gas turbine systems are mechanisms for converting potential energy, in the form of fuel, to thermal energy and then to mechanical energy for use in propelling aircraft, generating electric power, pumping fluids etc. At this time, an available avenue for improving efficiency of gas turbines is use of higher operating temperatures. However, metallic materials used in gas turbines may be very near the upper limits of their thermal stability at gas turbine operating temperatures. In the hottest temperature portions of gas turbines, some metallic materials may be used at temperatures above their melting points. The metallic materials may survive because they can be air cooled. However, air cooling may reduce overall gas turbine efficiency.

Thermal barrier coatings are applied to high temperature operating components, such as but not limited to those in gas turbine systems. With use of a thermal barrier coating, cooling air amounts can be substantially reduced. Thus, use of a thermal barrier coating can increase in gas turbine efficiency. Thermal barrier coatings can be applied to hot gas path components, such as but not limed to combustion liners, transition pieces, turbine nozzles, and turbine blades/buckets.

Ceramic materials are generally used in thermal barrier coatings. Yttria-stabilized zirconia (YSZ) is a ceramic that is often used in thermal barrier coatings. The cubic crystal structure of zirconia or zirconium dioxide (ZrO₂) has been stabilized at room temperature by an addition of yttrium oxide or yttria (Y₂O₃) to form YSZ. However, YSZ exhibits instability at higher temperatures and can decompose from its cubic crystal structure to a mixture of tetragonal and cubic zirconia, and thus not provide the full desired thermal barrier coating protection.

### BRIEF DESCRIPTION

All aspects, examples and features mentioned below can be combined in any technically possible way.

An aspect of the disclosure provides a high entropy ceramic (HEC) composition, the high entropy ceramic (HEC) composition comprising at least three different rare earth (RE) oxides; the at least three different rare earth oxides being equimolar fractions; and at least one of hafnium dioxide (HfO₂) and zirconium dioxide (ZrO₂).

Another aspect of the disclosure includes any of the preceding aspects, where the at least three different rare earth (RE) oxides include at least one of Yttrium (Y), Lanthanum (La), Cerium (Ce), Neodymium (Nd), Gadolinium (Gd), Samarium (Sm), Erbium (Er), and Ytterbium (Yb).

A further aspect of the disclosure includes any of the preceding aspects, and wherein at least three different rare earth (RE) oxides include at least three of Y₂O₃, La₂O₃, Gd₂O₃, Ce₂O₃, Nd₂O₃, Sm₂O₃, Yb₂O₃, and Er₂O₃.

A still further aspect of the disclosure includes any of the preceding aspects, and wherein the equimolar fraction of the at least three different rare earth oxides rare earth oxide is 0.167 mole each and the molar fraction of at least one of HfO₂ and ZrO₂ is 0.5 mole.

Yet another aspect of the disclosure includes any of the preceding aspects, wherein the equimolar fraction of the at least three different rare earth oxides rare earth oxide is 0.133 mole each and the molar fraction of at least one of HfO₂ and ZrO₂ is 0.6 mole.

Another further aspect of the disclosure includes any of the preceding aspects, wherein the equimolar fraction of the at least three different rare earth oxides rare earth oxide is 0.1 mole each and the molar fraction of at least one of HfO₂ and ZrO₂ is 0.7 mole.

Another aspect of the disclosure includes any of the preceding aspects, wherein the equimolar fraction of the at least three different rare earth oxides rare earth oxide is 0.067 mole each and the molar fraction of at least one of HfO₂ and ZrO₂ is 0.8 mole.

An aspect of the disclosure provides a thermal barrier coating, the thermal barrier coating comprising at least two layer thermal barrier coating layers, wherein at least one of the at least two thermal barrier coating layers includes a high entropy ceramic (HEC) composition, the high entropy ceramic (HEC) composition including: at least three different rare earth (RE) oxides; the at least three different rare earth oxides being equimolar fractions; and at least one of hafnium dioxide (HfO₂) and zirconium dioxide (ZrO₂).

In another aspect of the disclosure includes any of the preceding aspects, and where the at least three different rare earth (RE) oxides includes at least one of Yttrium (Y), Lanthanum (La), Gadolinium (Gd), Cerium (Ce), Neodymium (Nd), Samarium (Sm), Erbium (Er), and Ytterbium (Yb).

Another aspect of the disclosure includes any of the preceding aspects, and wherein the at least three different rare earth (RE) oxides include at least three of Y₂O₃, La₂O₃, Gd₂O₃, Nd₂O₃, Ce₂O₃, Sm₂O₃, Yb₂O₃, and Er₂O₃.

An additional aspect of the disclosure includes any of the preceding aspects, and wherein the equimolar fraction of each of the at least three different rare earth oxides rare earth oxide is 0.167 mole each and the molar fraction of at least one of HfO₂ and ZrO₂ is 0.5 mole.

Still another aspect of the disclosure includes any of the preceding aspects, and wherein the equimolar fraction of each of the at least three different rare earth oxides is 0.133 mole each and the molar fraction of at least one of HfO₂ and ZrO₂ is 0.6 mole.

Another further aspect of the disclosure includes any of the preceding aspects, and wherein the equimolar fraction of each of the at least three different rare earth oxides is 0.1 mole each and the molar fraction of at least one of HfO₂ and ZrO₂ is 0.7 mole.

Yet another aspect of the disclosure includes any of the preceding aspects, and wherein the equimolar fraction of each of the at least three different rare earth oxides rare earth oxide is 0.067 mole each and the molar fraction of at least one of HfO₂ and ZrO₂ is 0.8 mole.

In another aspect of the disclosure includes any of the preceding aspects, and wherein the thermal barrier coating includes a substrate, a bond coat deposited on the substrate, a butter layer deposited on the bond coat, a first high entropy ceramic (HEC) composition layer deposited on the butter layer, and a second high entropy ceramic (HEC) composition layer deposited on the first high entropy ceramic (HEC) composition layer.

Another aspect of the disclosure includes any of the preceding aspects, and wherein the one of the first high entropy ceramic (HEC) composition layer and the second high entropy ceramic (HEC) composition layer is deposited by suspension plasma spray (SPS) and forms a vertically cracked entropy ceramic composition (HEC) layer.

Another further aspect of the disclosure includes any of the preceding aspects, and the thermal barrier coating further including an abrasive protective coating deposited to the second high entropy ceramic (HEC) composition layer.

An aspect of the disclosure provides a method forming a layered article, the method comprising depositing at least two thermal barrier coating layers on a substrate, wherein at least one of the at least two thermal barrier coating layers includes a high entropy ceramic (HEC) composition layer, the high entropy ceramic (HEC) composition layer including: at least three different rare earth (RE) oxides; the at least three different rare earth oxides being equimolar fractions; and at least one of hafnium dioxide (HfO₂) and zirconium dioxide (ZrO₂).

Another aspect of the disclosure includes any of the preceding aspects, and wherein the at least three different rare earth (RE) oxides include at least three of Y₂O₃, La₂O₃, Gd₂O₃, Ce₂O₃, Nd₂O₃, Sm₂O₃, Yb₂O₃, and Er₂O₃.

Another aspect of the disclosure includes any of the preceding aspects, and wherein the method further includes depositing a bond coat on a substrate, depositing a butter layer on the bond coat, depositing a first high entropy ceramic (HEC) composition layer on the butter layer, and depositing a second high entropy ceramic (HEC) composition layer on the first high entropy ceramic (HEC) composition layer, wherein the one of the first high entropy ceramic (HEC) composition layer and the second high entropy ceramic (HEC) composition layer is deposited by suspension plasma spray (SPS) and forms a vertically cracked entropy ceramic composition (HEC) layer.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a table of high entropy ceramic (HEC) compositions, according to embodiments of the disclosure;

FIG. 2 illustrates a schematic thermal barrier coating system on a substrate with a high entropy ceramic (HEC) composition layer, according to embodiments of the disclosure;

FIG. 3 illustrates a further schematic thermal barrier coating system on a substrate with a high entropy ceramic (HEC) composition layer, according to a further embodiment of the disclosure:

FIG. 4 illustrates another schematic thermal barrier coating system on a substrate with a high entropy ceramic (HEC) composition layer, according to another embodiment of the disclosure; and

FIG. 5 illustrates a flowchart of a method for forming a thermal barrier coating including a high entropy ceramic (HEC) composition layer, according to embodiments of the disclosure;

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant thermal barrier coatings and compositions, especially with use in turbomachinery. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine engine or, for example, the flow of air through the combustor or coolant through one of the turbine's component systems. The term “downstream” corresponds to the direction of flow of the fluid, and the term “upstream” refers to the direction opposite to the flow (i.e., the direction from which the flow originates). The terms “forward” and “aft,” without any further specificity, refer to directions, with “forward” referring to the front or compressor end of the engine, and “aft” referring to the rearward section of the turbomachine.

It is often required to describe parts that are disposed at differing radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbine.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As discussed above, gas turbine systems convert potential energy to thermal energy and then to mechanical energy for use. Improving efficiency of a gas turbine is desirable and that improvement can be achieved by operating the gas turbine at higher temperatures. However, metallic materials used in gas turbines, especially at higher temperatures associated with hot gas path components may be very near the upper limits of their thermal stability at gas turbine operating conditions. In the hottest portions of gas turbines, some metallic materials may even be used at temperatures above their melting points. The metallic materials can survive because they can be cooled, for example by air, steam, or other cooling schema now known or hereinafter developed. However, cooling may reduce overall gas turbine efficiency.

Thermal barrier coatings may be applied to high temperature operating components, such as but not limited to, in gas turbine systems. With thermal barrier coatings, cooling air amounts for gas turbines can be reduced. Thus, thermal barrier coatings can increase in gas turbine efficiency. Thermal barrier coatings can be applied to hot gas path components, such as but not limed to combustion liners, transition pieces, turbine nozzles, and turbine blades/buckets.

Generally speaking, metallic materials, including those in gas turbines, have coefficients of thermal expansion that exceed those of ceramic materials. Consequently, ceramic materials in a thermal barrier coating should match its coefficient of thermal expansion to the coefficient of thermal expansion of the component substrate. Therefore, upon heating, when the substrate expands, the ceramic coating material does not crack. Zirconium dioxide ZrO₂ (“zirconia”) and hafnium dioxide HfO₂ (“hafnia”) both exhibit a high coefficient of thermal expansion, and thus zirconia and hafnia are used in thermal barrier coatings.

Thermal barrier coatings can be deposited by several techniques. As embodied by the disclosure, deposition techniques include, but are not limited to, thermal spraying (plasma, flame and HVOF), sputtering, and electron beam physical vapor deposition (EBPVD). Electron beam physical vapor deposition may produce a columnar grain microstructure that includes small columns separated by gaps which extend into the coating. This structure may be referred to as dense vertically cracked or DVC.

As noted above, yttria-stabilized zirconia. (YSZ) has been used as a thermal barrier coating for gas turbine engines. While YSZ performs well in this function, the need for increased operating temperatures to achieve higher energy conversion efficiencies, requires the development of improved materials. To meet this challenge, rare-earth zirconates that form cubic fluorite-derived pyrochlore structures may be used in thermal barrier coatings due to their low thermal conductivity, excellent chemical stability, and other suitable properties. The use of single phase high entropy multiphase components offers the potential for further drops in conductivity by greater phonon scattering due to higher concentrations of dopants in the lattice as well as higher hardness and toughness properties which will translate to improved erosion properties.

Pyrochlore generally describes a ceramic structure of the composition A₂B₂O₇ where A can have valance of 3⁺ or 2⁺ and B can have a balance of 4⁺ or 5⁺ and wherein the sum of the A and B valences is 7. Typical pyrochlores that have potential as thermal barrier coatings are those in which A is selected from the rare earth or lanthanide elements and mixtures thereof and B is selected from the group consisting of zirconium, hafnium and mixtures thereof. Many other pyrochlores exist which also have potential as thermal barrier materials.

Fluorite and pyrochlore are practically the same with respect to cubic structure. Hence, fluorite and pyrochlore can be taken as one phase. Fluorite and pyrochlore structure in RE₂O₃—ZrO₂ system are both are cubic structures, while difference being pyrochlore is ordered hence shows double lattice parameter to fluorite.

Aspects as embodied by the disclosure, include use of high entropy oxide ceramic compositions (HEC) exhibiting low/ultra-low thermal conductivity. HECs, as embodied by the disclosure, also exhibit desirable erosion resistance properties in a thermal barrier coating. HECs provide crystalline high-entropy single phase products in a thermal barrier coating with enhanced reductions in thermal conductivity and improved toughness over conventional thermal barrier coating chemistries. Thus, single phase HEC in a thermal barrier coating provide benefits over current thermal barrier coatings.

In terms of this application, the term “entropy” refers to a measure of molecular disorder, or configurational disorder, or randomness of a system, and in terms of this disclosure, a thermal barrier coating. Configurational disorder or entropy can be compositionally engineered into a mixed ceramic oxide. According to an aspect of the embodiments, entropy can be achieved by populating a single sublattice with many distinct cations, or positively charged ions. HEC, as embodied by the disclosure, promote entropy-stabilized forms of crystalline matter, which can be incorporated into thermal barrier coatings. HECs as embodied by the disclosure, enable single phase solid solution of oxides in a crystalline structure to a concentration level that provides thermal protection.

On a density adjusted basis, pyrochlores have thermal insulating properties that exceed those of the more commonly used zirconia-based thermal barrier materials. Additionally, many pyrochlore materials have a phase relationship in which the pyrochlore structure is phase stable up to the melting point. Most of the pyrochlores have melting points of more than about 3000° F. (about 1650° C.), and generally more than about 4000° F. (about 2200° C.). Some of the materials having a cubic and at least generally non-pyrochlore crystal structure, e.g., gadolinia-zirconia oxide (Gd,Zr)O₂ are also phase stable up to at least about 3000° F. (1650° C.). In the case of gadolinia zirconia oxide, transformation of pyrochlore gadolinia zirconate structure tends to be to the conventional cubic structure, which is also quite phase stable. Additionally, all of these materials adhere to alumina. These properties are all useful in thermal barrier coatings.

In order to improve the efficiency of gas turbines operating at high inlet temperatures, such as temperatures up to and above about 1300° C. (2400° F.), thermal barrier coatings provide low (“Low K”) to ultra-low thermal conductivity (“ULK”). Low to ultra-low thermal conductivity of a thermal barrier coating can enable higher temperature stability to lower temperatures on a substrate upon which the thermal barrier coating is applied. Therefore, an aspect of the embodiments sets forth a thermal barrier coating with high entropy ceramic (hereinafter “HEC”) compositions, with low K and ULK characteristics. HECs, as embodied by the disclosure, include high entropy alloyed oxide ceramic compositions. HECs, as embodied by the disclosure, include improved erosion resistance properties.

HEC materials, produced in accordance with aspects of the embodiments, create microstructures of a deposited coating to obtain highly durable ULK thermal barrier coatings. The thermal barrier coating with HEC as embodied by the disclosure, are stable at high gas turbine operating temperatures of up to and above about 1300° C. (2400° F.).

Additionally, HEC materials, produced in accordance with aspects of the embodiments, enable crystalline high-entropy single phase products to be formed. Crystalline high-entropy single phase products offer further reductions in thermal conductivity and improved toughness with respect to conventional thermal barrier coatings.

Configurational disorder or high entropy can be compositionally engineered into a mixed ceramic oxide by populating a single sublattice with many distinct cations. The compositionally engineered single sublattice formulations promote entropy-stabilized forms of crystalline compositions. In these entropy-stabilized forms of crystalline compositions, as embodied by the disclosure, cations are incorporated into the crystal structure, as discussed herein.

An aspect of the embodiments provides single phase solid solution of elemental constituents in the form of rare earth oxides of the elemental constituents. Rare earth oxides form a crystalline structure at a relatively high concentration level. Crystalline high entropy stabilized structures provide a low thermal conductivity, K, due at least in part to multiple elements with different atomic radii formed in the crystalline structure. This crystalline structure with different atomic radii permits increased of phonon scattering, and thus lower thermal conductivity, K.

Equimolar fraction constituents for low thermal conductivity, K, as embodied by the disclosure, include:
Low K (YₓZrₓGdₓZr) (Yₓ)Oₓ x=ratios can be from about 0.1 to about 0.25
ULK (YbₓZrₓGdₓZr) (Yₓ)O x=ratios can be from about 0.1 to about 0.25

A further aspect of the embodiments provides equimolar fraction systems for low thermal conductivity, K, as embodied by the disclosure, where a compositional formula for equimolar atomic fraction doped/substituted zirconia systems to include:
A: Low K: (RE_{x/3},RE_{x/3},RE_{x/3})Zr₍₁₋ₓ₎O_{2-∂} where RE=Y, La, Gd, Ce, Nd, Sm, Yb, Ce, Er
   Equimolar x=ratios can be from about 0.1 to about 0.3
   Examples: (Y_{0.06},La_{0.06},Gd_{0.06})Zr_{0.82}O_{1.91} and
      (Y_{0.06},Gd_{0.06},Yb_{0.06})Zr_{0.82}O_{1.91}
B: ULK: (RE_{x/4},RE_{x/4},RE_{x/4},RE_{x/4})Zr₍₁₋ₓ₎O_{2-∂} where RE=Y, La, Gd, Nd, Ce, Sm, Yb, Ce, Er
   equimolar x=ratios can be from about 0.1 to about 0.45
   Examples: (Y_{0.05}La_{0.05},Gd_{0.05},Ce_{0.05})Zr_{0.8}O_{1.9} and
      (Y_{0.05},La_{0.05},Gd_{0.05},Yb_{0.05})Zr_{0.8}O_{1.9}
C: ULK: (RE_{x/5},RE_{x/5},RE_{x/5},RE_{x/5})Zr₍₁₋ₓ₎O_{2-∂} where RE=RE=Y, La, Gd, Nd, Ce, Sm, Yb, Ce, Er
   equimolar x=ratios can be from about 0.1 to about 0.45
   Examples: (Y_{0.04},La_{0.04},Gd_{0.04},Ce_{0.04},Sm_{0.04})Zr_{0.8}O_{1.9} and
      (Y_{0.04},La_{0.04},Gd_{0.04},Yb_{0.04},Sm_{0.04})Zr_{0.8}O_{1.9}

Hafnia and zirconia are similar in both chemistry and monoclinic structure. Both hafnia and zirconia are fully soluble in each other to form solid solutions. Compounds with hafnia and zirconia formed with rare earth or lanthanide elements are tetragonal or cubic stabilized also tend to be similar. However, stabilized hafnia may be more structural stable upon aging at higher operating temperatures.

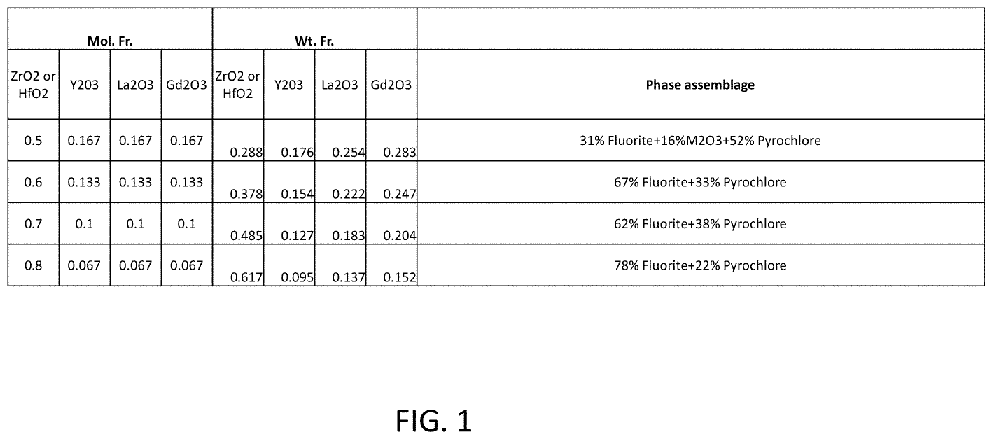

FIG. 1 is a table of illustrative and non-limiting high entropy ceramic (HEC) compositions, as embodied by the disclosure. In FIG. 1, the “phase assemblage” column provides gives the mole percent (%) of phases obtained in the HEC thermal barrier coating composition. FIG. 1 provides mole fractions of rare earth oxides and hafnia and zirconia, where values of the illustrative and non-limiting Y₂O₃, La₂O₃, Gd₂O₃, entries are in equimolar amounts. FIG. 1 also provides corresponding weight fractions of hafnia and zirconia as well as the illustrative Y₂O₃, La₂O₃, Gd₂O₃. While Y₂O₃, La₂O₃, Gd₂O₃ are listed as illustrative rare earth oxides in the table, the aspects of the embodiments, includes other rare earth oxides, such as but not limited to Y₂O₃, La₂O₃, Gd₂O₃, Ce₂O₃, Sm₂O₃, Nd₂O₃, Yb₂O₃, Ce₂O₃, Sm₂O₃, and Er₂O₃.

As discussed above, zirconia and hafnia are interchangeable in the HEC compositions. In one non-limiting aspect of the embodiments, the HEC composition includes all zirconia. In another non-limiting aspect, HEC composition includes all hafnia. And yet in another non-limiting aspect of the HEC composition contains amounts of zirconia and hafnia in amounts that add up the amount in FIG. 1.

Compositions, as embodied by the disclosure, may also contain certain oxide additives to inhibit sintering at high temperatures. An aspect of the embodiments provides oxide additives such as, but not limited to, alumina Al₂O₃, MgO, or CaO to inhibit sintering at high temperatures. In accordance with another aspect of the embodiments, in-situ formed complex oxides, such as but not limited to certain rare earth oxides, for example but not limited to, Y₃Al₅O₁₂, Gd₃Al₅O₁₂, YAlO₃, Nd₂O₃, GdAlO₃ can be added to compositions, as embodied by the disclosure, to inhibit sintering at high temperatures.

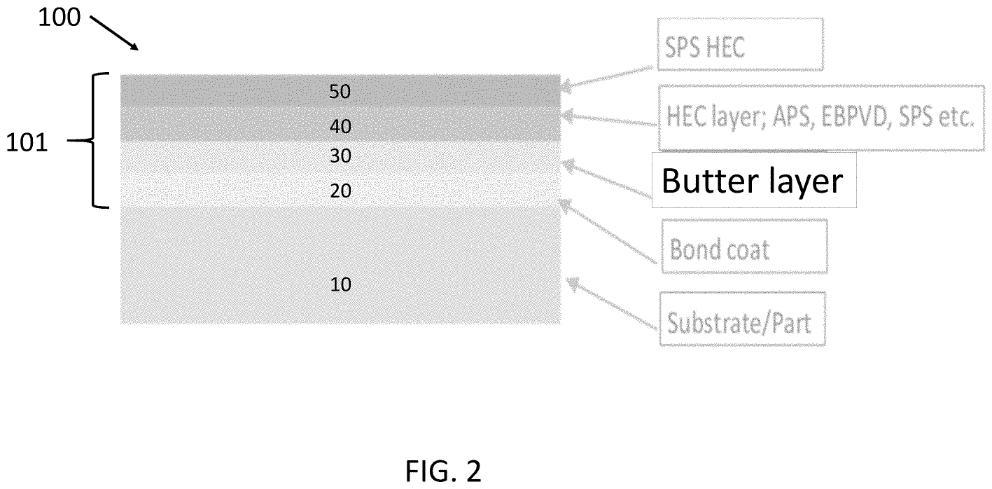

An aspect of the embodiments provides a thermal barrier coating system 100 with a high entropy oxide ceramic (HEC) thermal barrier coating and is illustrated in FIGS. 2-4. In accordance with aspects of the disclosure, the type and number of layers, their thicknesses and their arrangement in thermal barrier coating system 100 may be varied. The variation in type, number, thickness, and arrangement results in a thermal barrier coating 101 with HEC compositions providing desired properties on substrate 10 on which the thermal barrier coating system 100 is deposited.

With reference to FIGS. 2-4, thermal barrier coating system 100 includes thermal barrier coating 101 deposited on substrate 10. A bond coat 20 is deposited on substrate 10. An illustrative bond coat is a MCrAlX bond coat, where; M stands for metallic species, such as Fe, Co, Ni, and X stands for at least one of Y, Ti, Yb, and Ta.

A butter layer 30 is deposited on bond coat 20. Butter layer 30 provides compatible surfaces for subsequent layers in the thermal barrier coating 101.

Bond coat 20 and butter layer 30 may be deposited by any appropriate deposition method. In certain aspects as embodied by the disclosure, deposition method for bond coat 20 and butter layer 30 may include at least one of air plasma spray (APS), high velocity oxygen fuel (HVOF), electron-beam physical vapor deposition (EBPVD), and suspension plasma spray (SPS), or other spray deposition processes now known or hereinafter developed.

Next, at least two layers that include high entropy ceramic (HEC) compositions are deposited on butter layer 30. One layer is high entropy ceramic (HEC) composition layer 40 (FIG. 2) deposited by at least one of air plasma spray (APS), high velocity oxygen fuel (HVOF), electron-beam physical vapor deposition (EBPVD), and suspension plasma spray (SPS). The other layer is a high entropy ceramic (HEC) composition layer 50 (FIG. 2) deposited on high entropy ceramic (HEC) composition layer 40 by suspension plasma spray (SPS). As discussed herein, SPS provides desirable higher strength and toughness in thermal barrier coating 101, compared to other thermal barrier coating systems.

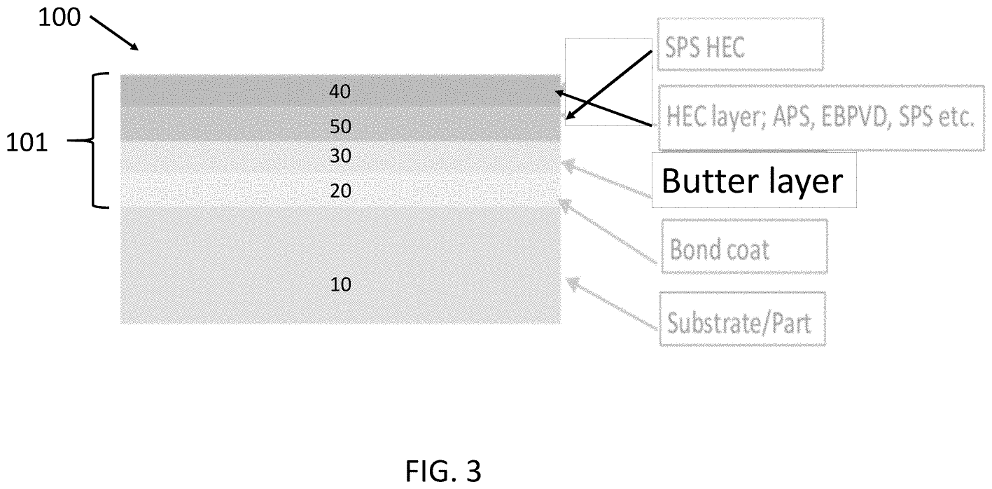

Thermal barrier coating system 100 configuration of FIG. 3, inverts the positioning of HEC composition layer 40 and HEC composition layer 50. In FIG. 3, HEC composition layer 50 is deposited by suspension plasma spray (SPS) on butter layer 30 that can be for illustrative purposes only and not limiting of the embodiments in any manner a butter layer including 8YSZ applied by APS, and HEC composition layer 40 is deposited by at least one of air plasma spray (APS), high velocity oxygen fuel (HVOF), electron-beam physical vapor deposition (EBPVD), and suspension plasma spray (SPS) over HEC composition layer 50, or by another other suitable deposition process now known or hereinafter developed.

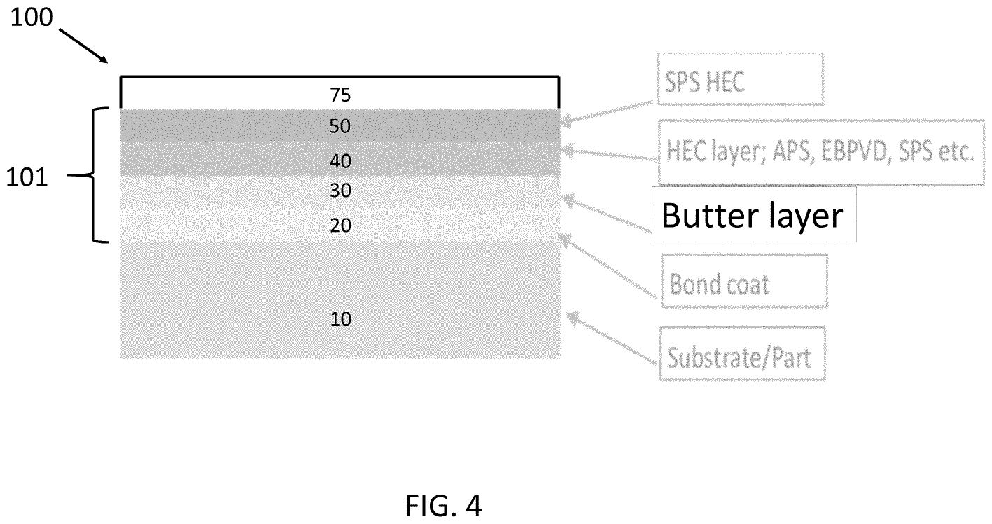

FIG. 4 illustrates the thermal barrier coating system 100 with a protective layer 75 disposed on the outermost HEC composition layer 40 and HEC composition layer 50. Protective layer 75 can include at least one property to protect thermal barrier coating 101. As embodied by the disclosure, layer 75 may provide the thermal barrier coating 101 with more toughness, abradable or abrasive protection properties, environmentally protective properties, increased aerodynamics, smoother (lower Ra), erosion and abrasion resistance properties, and resistance properties to aggressive chemicals, among other desirable thermal barrier coating properties, now known or hereinafter desired.

In accordance with a further aspect of the embodiments, a method to prepare HEC compositions for use, including use as a thermal barrier coating, is provided. The method, as embodied by the disclosure, can be utilized to deposit an HEC layer as part of a thermal barrier coating on a substrate or component, which benefit from high temperature protection.

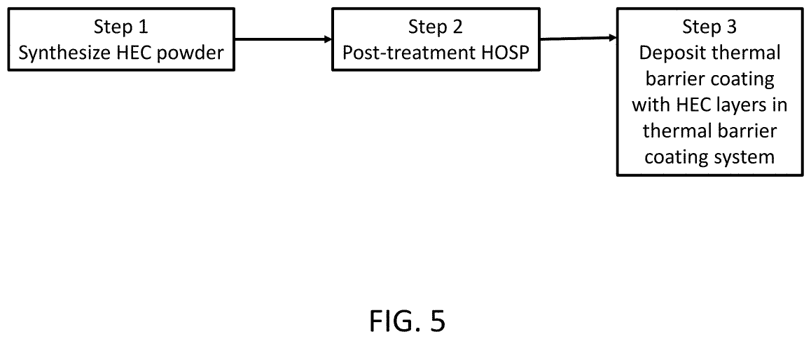

With reference to FIG. 5, steps to prepare HEC compositions may include:

Step 1: HEC raw material (feedstock), under controlled conditions is used to create a single-phase crystalline microstructure material or create a multi-phase HEC crystalline microstructure material. A powder synthesis may be used to prepare HEC raw powder material. Step 1 induces evaluation of powder phases to determine phase constituents. Subsequent separating of a desired single phase from other phases in the HEC raw powder material will arrive as a blend of HEC raw powder material.

Step 2: Apply a hollow oven spherical process (HOSP) to the HEC raw powder material. HOSP will enhance low k characteristics of the HEC raw powder material. HOSP passes HEC raw powder material through a heat source, such as a plasma torch. Thereafter, HEC raw powder material is collected in a chamber. As embodied by the disclosure, the chamber may include water. However, other aspects of the embodiments may include other mediums in the chamber. HEC raw materials may also be further heat treated after being in the chamber. Heat treatment of HEC raw material can create desired HEC crystalline phases. The heat treatment of the HEC raw material may improve strength of the HEC material with its crystalline phases.

Step 3: Various deposition processes can be used for depositing HEC material with crystalline phases in a layer on a substrate or prepared surface. Illustrative, but non-limiting deposition processes, include air plasma spray, electron-beam physical vapor deposition (EBPVD), and suspension plasma spray (SPS), and other spray deposition methods now known or hereinafter developed. HEC material with crystalline phases may be deposited on a MCrAlX bond coat, where; M stands for metallic species, such as Fe, Co, Ni, and X stands for at least one of Y, Ti, Yb, and Ta. Step 3 may be augmented by creating dense vertical cracked layers (DVC) in the HEC layer with crystalline phases, where DVC layers improve the strain tolerance of the HEC material with crystalline phases as deposited.

A further aspect of the process, as embodied by the disclosure, provides suspension plasma spray (SPS) processing in Step 3. SPS is capable of depositing dense layers of HEC material with crystalline phases using HEC raw powder material. SPS process results in a higher strength and toughness thermal barrier coatings compared to some conventional thermal barrier coatings.

Depositing of bond coat layer 20 and butter layer 30 of thermal barrier coating system 100 can be done by any deposition method now known or herein after developed. Bond coat layer 20 is initially deposited on substrate 10. Butter layer 30 is then deposited on bond coat 20. Thereafter HEC layer 40 is applied and then HEC layer 50 by SPS (FIG. 2). Of course, as noted above, the order of applying HEC layer 40 and HEC layer 50 can be inverted (FIG. 3). Moreover, a protective layer 75 may be applied over the last applied HEC layer of thermal barrier coating 101 in thermal barrier coating system 100.

Benefits of the HEC thermal barrier coating, as embodied by the disclosure, include increased thermal insulation with good erosion resistance properties. HEC thermal barrier coating, as embodied by the disclosure, allows higher gas turbine efficiency with increased reliability with improved thermal insulation, thus enabling increased TBC life with respect to YSZ. Other benefits of HEC thermal barrier coatings, as embodied by the disclosure, include reduced required cooling flow in the gas turbine, improved (longer) maintenance and repair intervals, and higher gas turbine operating temperatures.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

1. A high entropy ceramic (HEC) composition, the high entropy ceramic (HEC) composition comprising:
at least three different rare earth (RE) oxides; the at least three different rare earth oxides being equimolar fractions; and
at least one of hafnium dioxide (HfO₂) and zirconium dioxide (ZrO₂).

2. The high entropy ceramic (HEC) composition according to claim 1, where the at least three different rare earth (RE) oxides include at least one of Yttrium (Y), Lanthanum (La), Cerium (Ce), Neodymium (Nd), Gadolinium (Gd), Samarium (Sm), Erbium (Er), and Ytterbium (Yb).

3. The high entropy ceramic (HEC) composition according to claim 2, wherein at least three different rare earth (RE) oxides include at least three of Y₂O₃, La₂O₃, Gd₂O₃, Ce₂O₃, Nd₂O₃, Sm₂O₃, Yb₂O₃, and Er₂O₃.

4. The high entropy ceramic (HEC) composition according to claim 1, wherein the equimolar fraction of the at least three different rare earth oxides rare earth oxide is 0.167 mole each and the molar fraction of at least one of HfO₂ and ZrO₂ is 0.5 mole.

5. The high entropy ceramic (HEC) composition according to claim 1, wherein the equimolar fraction of the at least three different rare earth oxides rare earth oxide is 0.133 mole each and the molar fraction of at least one of HfO₂ and ZrO₂ is 0.6 mole.

6. The high entropy ceramic (HEC) composition according to claim 1, wherein the equimolar fraction of the at least three different rare earth oxides rare earth oxide is 0.1 mole each and the molar fraction of at least one of HfO₂ and ZrO₂ is 0.7 mole.

7. The high entropy ceramic (HEC) composition according to claim 1, wherein the equimolar fraction of the at least three different rare earth oxides rare earth oxide is 0.067 mole each and the molar fraction of at least one of HfO₂ and ZrO₂ is 0.8 mole.

8. A thermal barrier coating, the thermal barrier coating comprising:
at least two thermal barrier coating layers, wherein at least one of the at least two thermal barrier coating layers includes a high entropy ceramic (HEC) composition, the high entropy ceramic (HEC) composition including:
at least three different rare earth (RE) oxides; the at least three different rare earth oxides being equimolar fractions; and
at least one of hafnium dioxide (HfO₂) and zirconium dioxide (ZrO₂).

9. The thermal barrier coating according to claim 8, where the at least three different rare earth (RE) oxides includes at least one of Yttrium (Y), Lanthanum (La), Gadolinium (Gd), Cerium (Ce), Neodymium (Nd), Samarium (Sm), Erbium (Er), and Ytterbium (Yb).

10. The thermal barrier coating according to claim 9, wherein the at least three different rare earth (RE) oxides include at least three of Y₂O₃, La₂O₃, Gd₂O₃, Nd₂O₃, Ce₂O₃, Sm₂O₃, Yb₂O₃, and Er₂O₃.

11. The thermal barrier coating according to claim 8, wherein the equimolar fraction of each of the at least three different rare earth oxides rare earth oxide is 0.167 mole each and the molar fraction of at least one of HfO₂ and ZrO₂ is 0.5 mole.

12. The thermal barrier coating according to claim 8, wherein the equimolar fraction of each of the at least three different rare earth oxides is 0.133 mole each and the molar fraction of at least one of HfO₂ and ZrO₂ is 0.6 mole.

13. The thermal barrier coating according to claim 8, wherein the equimolar fraction of each of the at least three different rare earth oxides is 0.1 mole each and the molar fraction of at least one of HfO₂ and ZrO₂ is 0.7 mole.

14. The thermal barrier coating according to claim 8, wherein the equimolar fraction of each of the at least three different rare earth oxides rare earth oxide is 0.067 mole each and the molar fraction of at least one of HfO₂ and ZrO₂ is 0.8 mole.

15. The thermal barrier coating according to claim 8, wherein the thermal barrier coating includes a substrate, a bond coat deposited on the substrate, a butter layer deposited on the bond coat, a first high entropy ceramic (HEC) composition layer deposited on the butter layer, and a second high entropy ceramic (HEC) composition layer deposited on the first high entropy ceramic (HEC) composition layer.

16. The thermal barrier coating according to claim 15, wherein the one of the first high entropy ceramic (HEC) composition layer and the second high entropy ceramic (HEC) composition layer is deposited by suspension plasma spray (SPS) and forms a vertically cracked entropy ceramic composition (HEC) layer.

17. The thermal barrier coating according to claim 15, the thermal barrier coating further including an abrasive protective coating deposited to the second high entropy ceramic (HEC) composition layer.

18. A method forming a layered article, the method comprising:
depositing at least two thermal barrier coating layers on a substrate, wherein at least one of the at least two thermal barrier coating layers includes a high entropy ceramic (HEC) composition layer, the high entropy ceramic (HEC) composition layer including:
at least three different rare earth (RE) oxides; the at least three different rare earth oxides being equimolar fractions; and
at least one of hafnium dioxide (HfO₂) and zirconium dioxide (ZrO₂).

19. The method according to claim 18, wherein the at least three different rare earth (RE) oxides include at least three of Y₂O₃, La₂O₃, Gd₂O₃, Ce₂O₃, Nd₂O₃, Sm₂O₃, Yb₂O₃, and Er₂O₃.

20. The method according to claim 19, wherein the method further includes depositing a bond coat on a substrate, depositing a butter layer on the bond coat, depositing a first high entropy ceramic (HEC) composition layer on the butter layer, and depositing a second high entropy ceramic (HEC) composition layer on the first high entropy ceramic (HEC) composition layer, wherein the one of the first high entropy ceramic (HEC) composition layer and the second high entropy ceramic (HEC) composition layer is deposited by suspension plasma spray (SPS) and forms a vertically cracked entropy ceramic composition (HEC) layer.
